(19) United States
(12) Patent Application Publication
(10) Pub. No.: US 2020/0180806 A1
(43) Pub. Date: Jun. 11, 2020

(54) Dual Compartment Container with Scoop

(71) Applicant: Plastek Industries, Inc., Erie, PA (US)

(72) Inventors: H Stephen Quinn, Eau Claire, WI (US); Nicholas John Seager, Norwich, CT (US)

(73) Assignee: Plastek Industries, Inc., Erie, PA (US)

(21) Appl. No.: 16/709,091

(22) Filed: Dec. 10, 2019

Related U.S. Application Data
(60) Provisional application No. 62/777,636, filed on Dec. 10, 2018.

(51) Int. Cl. B65D 1/24; B65D 43/16; B65D 51/18; B65B 1/02; B65B 1/04; B65B 7/28; B65D 77/24; B29C 49/04; B29C 49/48

(52) U.S. Cl. CPC B65D 1/24; B65D 43/162; B65D 51/18; B65B 1/02; B65B 1/04; B29L 2031/712; B65D 77/245; B29C 49/04; B29C 49/4802; B65D 2251/0021; B65D 2251/0093; B65B 7/28

(57) ABSTRACT

A container has a container body and a closure. The body has a first compartment having a first opening and a second compartment having a second opening. The closure has a base mounted to the container body and a lid hinged to the base.

### CROSS-REFERENCE TO RELATED APPLICATION

Benefit is claimed of U.S. Patent Application No. 62/777,636, filed Dec. 10, 2018, and entitled “Dual Compartment Container with Scoop”, the disclosure of which is incorporated by reference herein in its entirety as if set forth at length.

### BACKGROUND

The disclosure relates to containers for powdered food, food supplement, and similar products. More particularly, the disclosure relates to tubs pre-packaged with scoops for dispensing the product.

A long and well-developed art exists in containers for powdered food products, supplements, and the like. Exemplary product includes infant formula, adult meal replacement, drink mix, health and fitness supplements, and the like. This container art includes tubs with hinged closures and jars with screw-off closures. In both such situations, a scoop will typically be pre-packaged in the interior of the container.

Packaging with a scoop can create several problems. First, the scoop will usually be placed in the container before filling. This leaves the scoop buried under the product. The user must thus dig through the product to grasp the scoop for first use. Even if the scoop was introduced later, the scoop may settle into the product during shipping and handling.

Additionally, if the initial fill level is high, it may be difficult for the user to replace the scoop into the interior after pulling it out. This is because it is mechanically easy to pull a scoop out of powdered product but inserting the scoop into powdered product is difficult due to the flow properties of the powder in view of the tensile versus compressive properties of the scoop.

### SUMMARY

One aspect of the disclosure involves a container comprising: a container body having a first compartment having a first opening and a second compartment having a second opening; and a closure having: a base mounted to the container body; and a lid hinged to the base.

In one or more embodiments of any of the foregoing embodiments, the container body has a first rim at the first compartment and a second rim at the second compartment and the closure base has a wall engaging the container body around the first rim.

In one or more embodiments of any of the foregoing embodiments, a scoop is stored in the second compartment and a powder product is stored in the first compartment.

In one or more embodiments of any of the foregoing embodiments, a seal is over the first compartment.

In one or more embodiments of any of the foregoing embodiments, the container body has: a first section bounding the first compartment and extending to a first rim; a second section bounding the second compartment and extending to the second rim; and a web joining the first portion and second portion.

In one or more embodiments of any of the foregoing embodiments, the closure base has an interlocking engagement with a neck of the first section and a neck of the second section.

In one or more embodiments of any of the foregoing embodiments, the interlocking engagement with the neck of the first section and the neck of the second section is along portions of the neck of the first section and the neck of the second section facing outward but not along portions of the neck of the first section and neck of the second section facing each other.

In one or more embodiments of any of the foregoing embodiments, the first compartment has a generally D-shaped footprint with a first leg facing the second compartment and an opposite second leg, the first leg being relatively straight compared with the second leg.

In one or more embodiments of any of the foregoing embodiments, the container body comprises a laminate.

In one or more embodiments of any of the foregoing embodiments, the first compartment and the second compartment are of a single molding.

In one or more embodiments of any of the foregoing embodiments, the first compartment and the second compartment are of separate moldings.

In one or more embodiments of any of the foregoing embodiments, a first molding of the separate moldings has a T-sectioned rail and a second molding of the separate moldings has a channel receiving the rail.

In one or more embodiments of any of the foregoing embodiments, the channel has a first segmented sidewall and a second segmented sidewall and the segments of the first sidewall alternate with the segments of the second sidewall.

In one or more embodiments of any of the foregoing embodiments, the T-rail and the channel are bonded to each other.

In one or more embodiments of any of the foregoing embodiments, a method for making the container comprises: extrusion blow molding the container body, the extrusion blow molding including pinching to divide the second compartment from the first compartment; and mating the closure to the container body.

In one or more embodiments of any of the foregoing embodiments, the method further comprises: placing a scoop in the second compartment; and introducing a powder product to the first compartment.

In one or more embodiments of any of the foregoing embodiments, the method further comprises, after the introducing of the powder, applying a seal across the first compartment.

In one or more embodiments of any of the foregoing embodiments, the applying of the seal does not seal the second compartment.

In one or more embodiments of any of the foregoing embodiments, the mating of the closure is via downward translation relative to the container body.

In one or more embodiments of any of the foregoing embodiments, a method for using the container comprises: opening the closure from a closed condition to an open condition; removing a scoop from the second compartment; and using the scoop to scoop powdered product from the first compartment.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an oblique view of a container in a closed condition.

FIG. 2 is an opening end view of the closed container.

FIG. 3 is a top view of the closed container.

FIG. 4 is a central median vertical sectional view of the closed container, taken along line 4-4 of FIG. 3.

FIG. 5 is a vertical sectional view through a hinge of the closed container taken along line 5-5 of FIG. 3.

FIG. 5A is an enlarged view of a latching area of the container.

FIG. 6 is a transverse vertical sectional view of the closed container taken along line 6-6 of FIG. 4.

FIG. 7 is a transverse vertical sectional view of the closed container taken along line 7-7 of FIG. 4.

FIG. 8 is a transverse vertical sectional view of the closed container taken along line 8-8 of FIG. 4.

FIG. 9 is an exploded view of a closure, scoop, and seal of the container with closure in an open condition.

FIG. 10 is a view of a body of the container.

FIG. 11 is a first side view of the container body

FIG. 12 is a top view of the container body.

FIG. 13 is a horizontal sectional view of the container body, taken along line 13-13 of FIG. 11.

FIG. 14 is a view of the closure in the open condition

FIG. 15 is an assembled view of a two-part container body assembly.

FIG. 16 is a side view of the assembled two-part container body assembly.

FIG. 17 is a top view of the assembled two-part container body assembly.

FIG. 17A is an enlarged view of a joint of the assembled two-part container body assembly.

FIG. 18 is an exploded/rotated view of the two-part container body assembly.

FIG. 19 is an exploded top view of the two-part container body assembly.

FIG. 19A is an enlarged view of a joint of the assembled two-part container body assembly.

Like reference numbers and designations in the various drawings indicate like elements.

### DETAILED DESCRIPTION

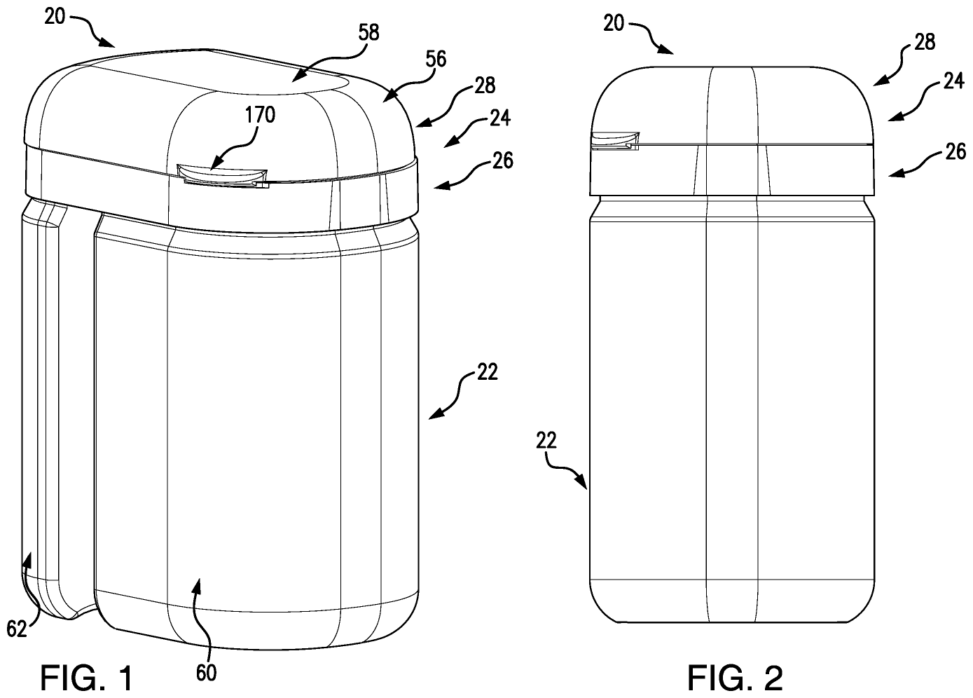

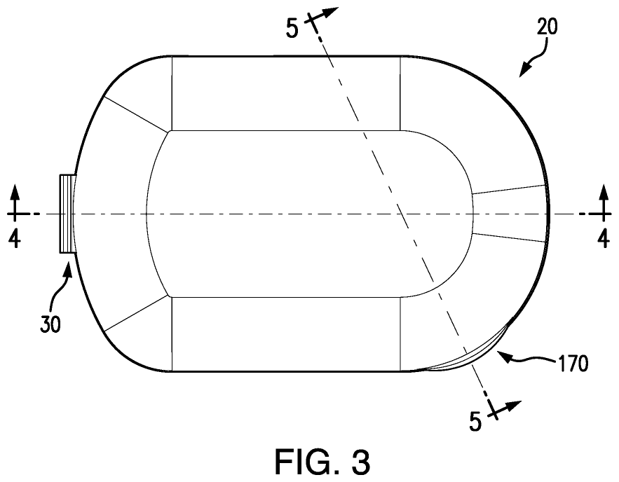

A container 20 (FIGS. 1 and 2) comprises a container body 22 and a closure 24. The closure comprises a base 26 mounted to the body and a lid 28 mounted to the base by a hinge 30 (FIG. 3). The exemplary hinge is a living hinge and the exemplary base, lid, and living hinge are unitarily molded as a single piece.

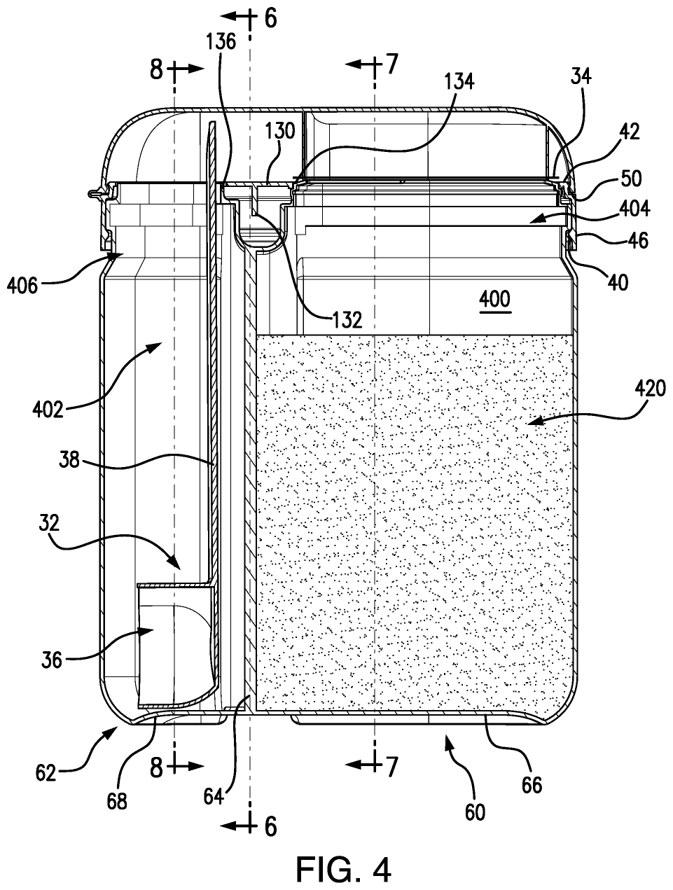

In an as-sold condition, the container with product may further contain a scoop 32 (FIG. 4) and include a seal 34 (shown exploded as an artifact of a CAD model). Additional conventional artifacts of manufacture and sale such as labels, tamper-evident shrink-wrapping, and the like may be present. Additionally, the product 420 is only shown in FIG. 4.

The exemplary container 20 provides a first compartment 400 for containing the product and a second compartment 402 for containing the scoop. The two compartments are formed by separate compartments 404, 406 within the container body but are covered by a single shared closure 24. The container body is thus formed as a two-compartment tub. The closure, however, may be subdivided to isolate the compartments from each other. Division may be achieved by a dividing wall (discussed below) on the lid of the closure.

The exemplary scoop and closure are injection molded of plastic (e.g., polypropylene or polyethylene (e.g., HDPE)). The exemplary scoop is molded as the single-piece unitary combination of a bowl 36 and a handle 38 extending from a proximal end at the bowl to a distal end. The exemplary closure is molded in an open condition and then, after ejection from the mold, closed via flexing of the living hinge 30 to rotate the lid by 180 degrees about the hinge axis.

The closure base 26 extends from a lower rim 40 to an upper rim 42 and has an interior surface 44 and an exterior surface 46. The interior surface may bear features (discussed below) for mating with the container body. The closure base exterior surface 46, near the upper rim, may bear features for mating with the lid in the closed condition. This may include a circumferential bead and channel arrangement and an additional latch opposite the hinge.

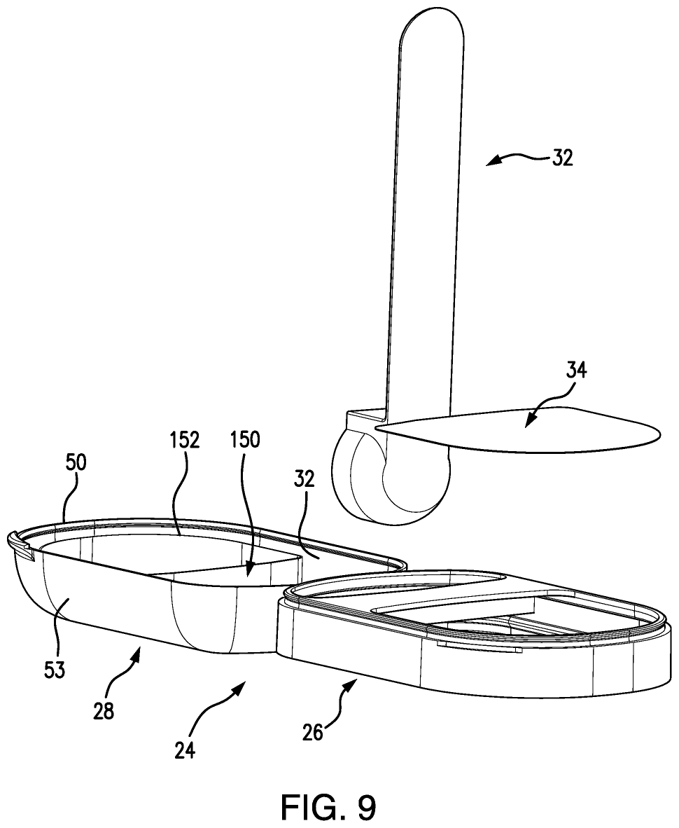

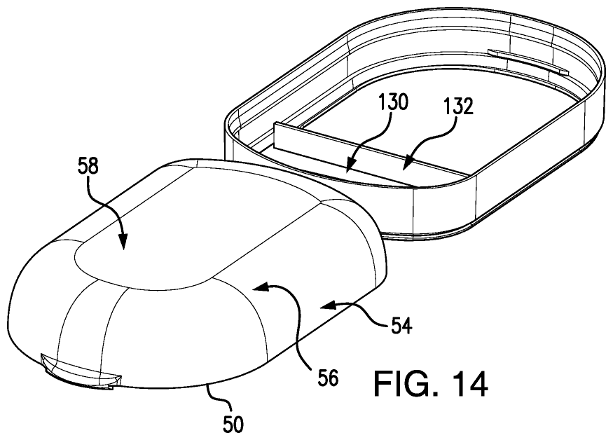

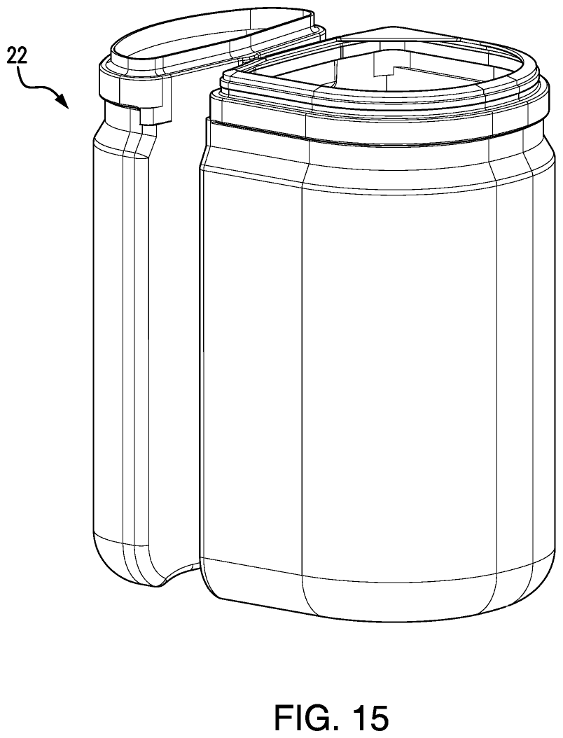

The closure lid 28 Extends to a lower rim 50 (FIG. 9 - lower and upper referencing a default closed condition with the container upright on a horizontal surface) and has an interior surface 52 and an exterior surface 53. The surfaces extend from the rim 50 along a sidewall portion 54 (FIG. 14), through a shoulder portion 56, to an upper web 58.

The container body 22 is divided into a first section 60 (FIG. 1) and a second section 62. The container body first section forms a container body first compartment which, in turn, forms a lower portion of the container first compartment. Similarly, the container body second section defines a container body second compartment forming a lower portion of the container second compartment. Exemplary manufacture of the container body is via an extrusion blow molding with a transverse pinch dividing what was initially one compartment into precursors of the two 404, 406 and leaving a web 64 (FIGS. 4&11) between the first section 60 and second section 62. This pinch may be part of the same mold closing that pinches/seals the extruded parison. First and second separate air nozzles respectively blow each compartment to shape. The first section 60 and second section 62 have respective bases 66, 68 which combine to form a base of the container body and container. Thus, exemplary undersides of the bases 66 and 68 may be sufficiently coplanar to support the container atop a flat surface.

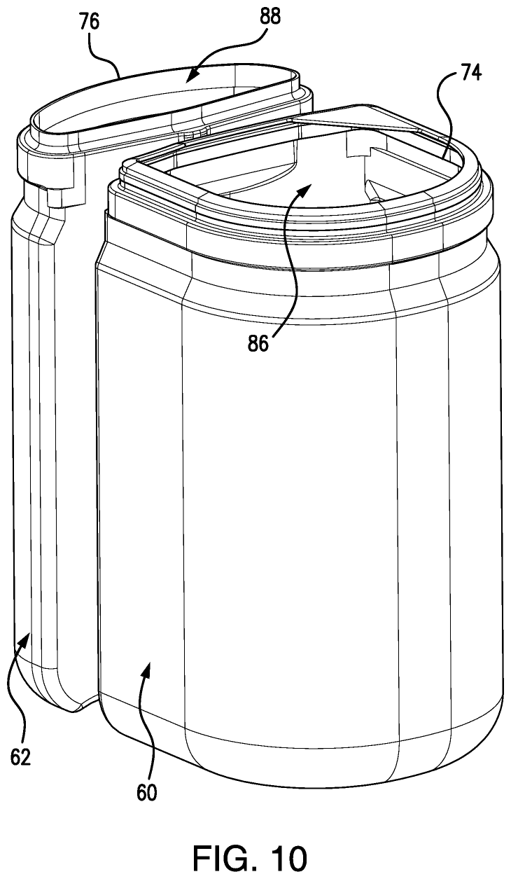

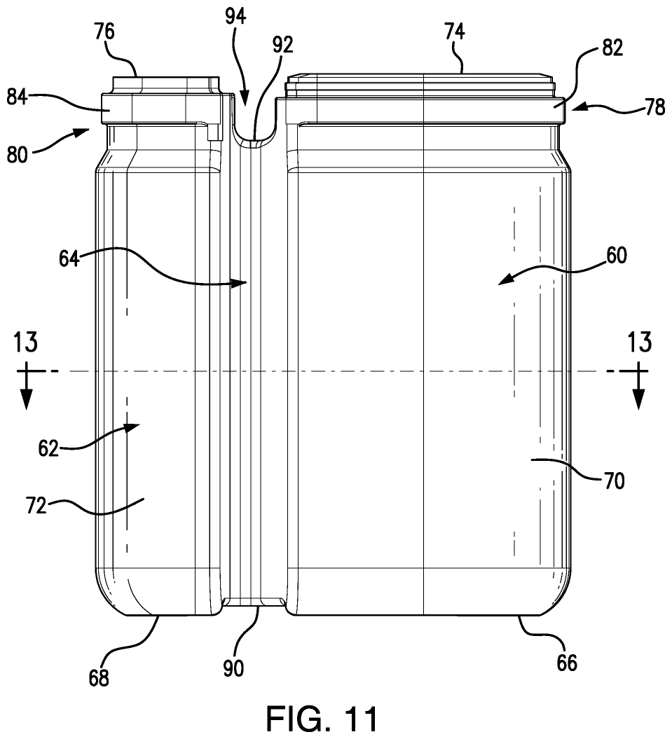

The respective sections 60 and 62 have sidewalls 70 and 72 (FIG. 11) extending upward from junctions with the bases 66, 68 and merging to form the web 64. The respective sections 60 and 62 have respective upper rims 74 and 76 and neck portions 78 and 80 below the rims. The respective neck portions include at least partial outward ribs 82 and 84 for mounting the closure base. The rims 74 and 76 bound respective openings 86, 88 (FIG. 10) of the container body compartments 404 and 406.

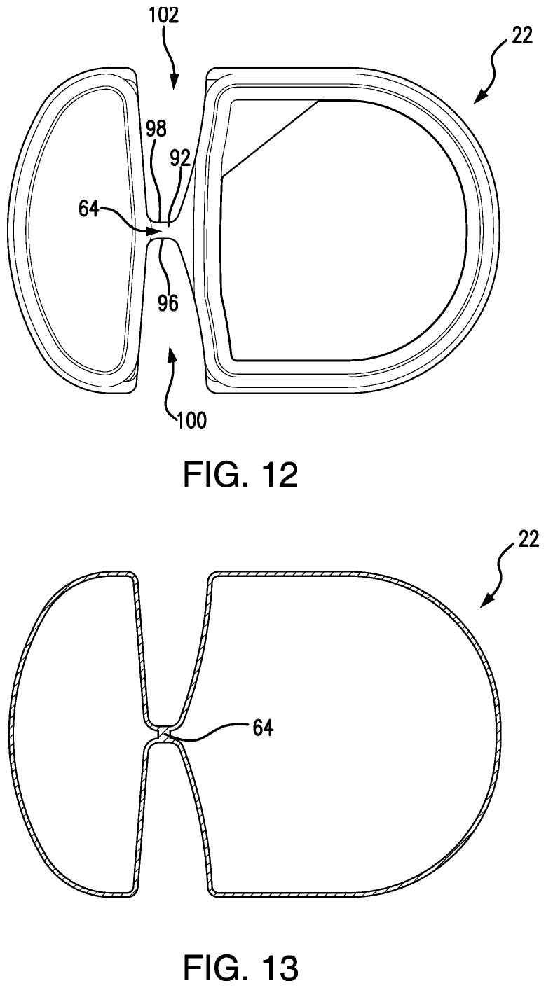

Respective lower and upper extremities 90 and 92 of the web 64 (FIG. 11) are vertically recessed from extremities of the bases 66, 68 on the one hand and rims 74, 76 on the other hand. This leaves an upper gap 94 between the two sections. Additionally, the web has lateral surfaces 96, 98 (FIG. 12) forming bases of lateral channels 100, 102 separating the two sections 60 and 62. The exemplary container body material is high density polyethylene (HDPE) optionally with conventional barrier layers (against oxygen, light, and the like) for product freshness. A multi-layer parison may be formed (e.g., extruded) to provide the multi-layered or laminate container body structure. Multiple gates may be used to introduce sequential layers when forming the parison. The parison is then pinched and blown.

In one example, the HDPE is an outer layer and inner layers provide a barrier. Among possible layerings are a structural HDPE outer layer, an intermediate ethylene vinyl alcohol (EVOH) layer as an oxygen barrier, and an inner liner layer of HDPE or polyethylene terephthalate (PET). Conventional adhesion layers may intervene between such layers.

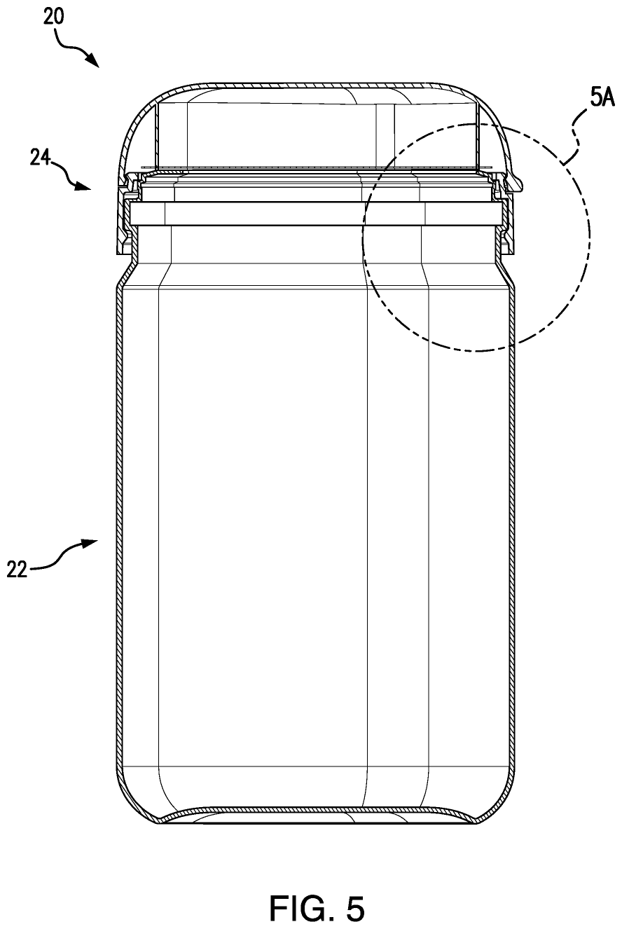

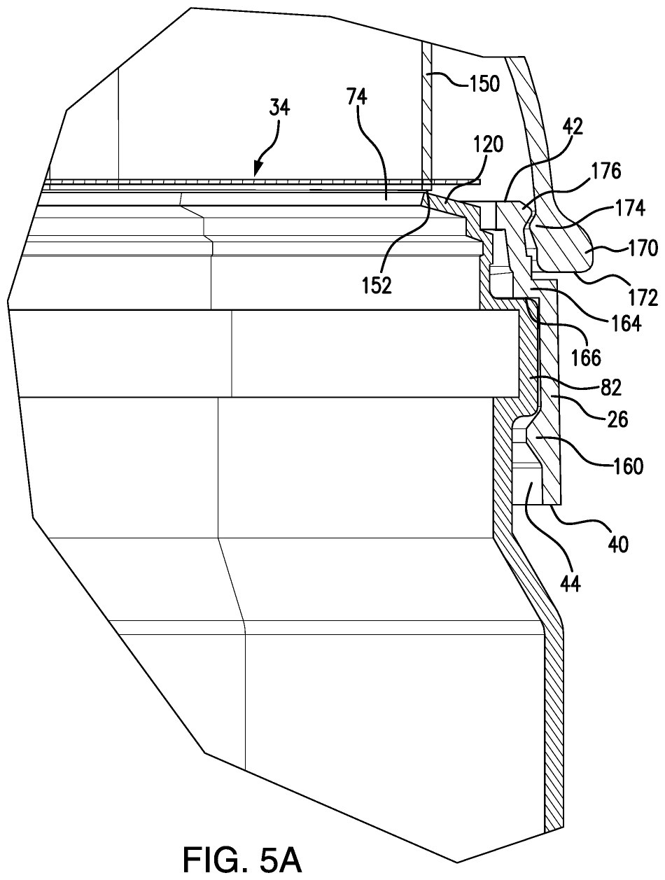

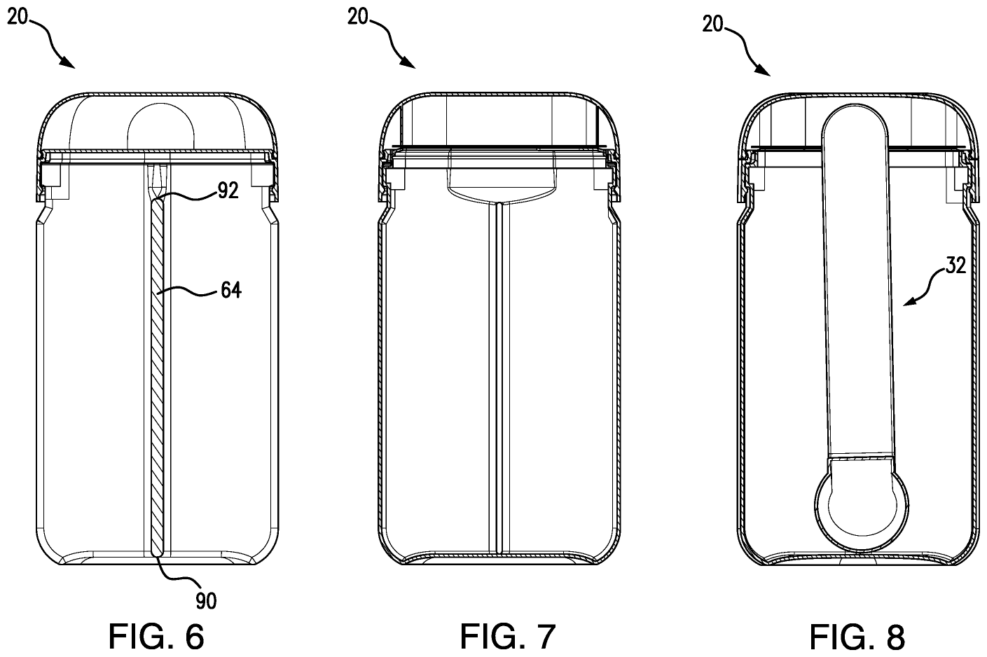

To help provide sealing with the lid (as discussed further below), the first section 60 (FIG. 5A) has, proximally of its rim 74, a tapering shoulder portion 120 extending upward toward the rim 74 at an angle off-vertical and off-horizontal. An exemplary relaxed angle is between 10 and 40 degrees off-horizontal

The exemplary closure 24 has a horizontal web 130 (FIG. 4) at the upper rim of the closure base from which depends a vertical wall 132. The adjacent edges 134, 136 of the web mate with adjacent surfaces of the two body sections 60, 62 aside respective portions of rims of the associated compartment 404, 406. The depending wall 132 provides a structural reinforcement accommodated in the upper gap 94 between respective sections forming the respective compartments. Additionally, the lid 28 includes a wall structure 150 (FIGS. 5A&9) which in the closed condition, isolates the second compartment from the first. The exemplary embodiment includes a fully circumscribing wall 150 that mates with the first section adjacent the rim thereof. In the exemplary embodiment, a lower rim 152 of the wall 150 contacts the portion 120 to flex the portion 120 downward to provide a sealing effect. FIG. 5A reflects computer modal artifacts showing the seal 34 slightly exploded out of place.

In the pre-use condition, the seal 34 (metal foil or plastic film) may extend across the first section and be engaged by the depending wall 150 of the lid. In the illustrated example, the seal 34 may be adhered to the outer/exterior surface of the first section 60 along the portion 120, clamped between that outer/exterior surface and the lower rim surface 152 of the wall structure 150. After removal of the seal 34 by a consumer, the depending wall 150 may directly contact the portion 120 of the first section 60 upon re-closing.

FIG. 5A further shows the base 26 retained to the container body 22 via an inwardly-protruding rib (projection) 160 engaging the underside of the ribs 82 and 84 of the sections 60 and 62. The exemplary base 26 has an inwardly extending shoulder 164 with an underside 166 engaging an upper surface of the ribs 82 and 84 to cooperate with the projection 160 to capture the ribs 82 and 84 vertically.

FIG. 5A further shows a latch tab 170 whose underside 172 may be pried up by a user's hand to disengage cooperating ribs/projections 174 and 176 of the lid and base, respectively, to allow the user to open the lid. An underside of the projection 174 and an upper surface of the projection 176 are angled to allow a camming action upon reclosing so the projections pass over center and then the upper surface of the projection 174 and lower surface of the projection 176 detent the closed condition.

The container may be made using otherwise conventional or yet-developed materials and techniques.

As noted above, in one example, scoops and closures are injection molded and container bodies are extrusion blow molded. On an automated assembly line or otherwise, assembly may involve inserting scoops into the second compartments (e.g., dropping-in) and introducing the powder product to the first compartment either before or after (e.g., pouring). At least after the product is introduced, the seal may be applied by a downward compression and heat sealing or adhesive sealing generally (with or without heat). On a separate assembly line, optionally including the molding of the closures, the closures may be hinged from their as-molded open condition to the closed condition which snaps the closure into the detented closed condition. The closures may then be installed to the container bodies via downward insertion again causing a snap engagement with an initial over-center action by the underside of the rib 160 and the upper surfaces of the ribs 82 and 84 leading to a relaxed locked condition capturing the ribs 82 and 84 between the projection 160 and shoulder 164 (or other feature such as a second rib). If not already applied, a label may be applied to the container body and a shrink wrap tamper-evident seal may be added. Additional variations may attend additional features such as alternative latches and tamper-evident features integral with the closure.

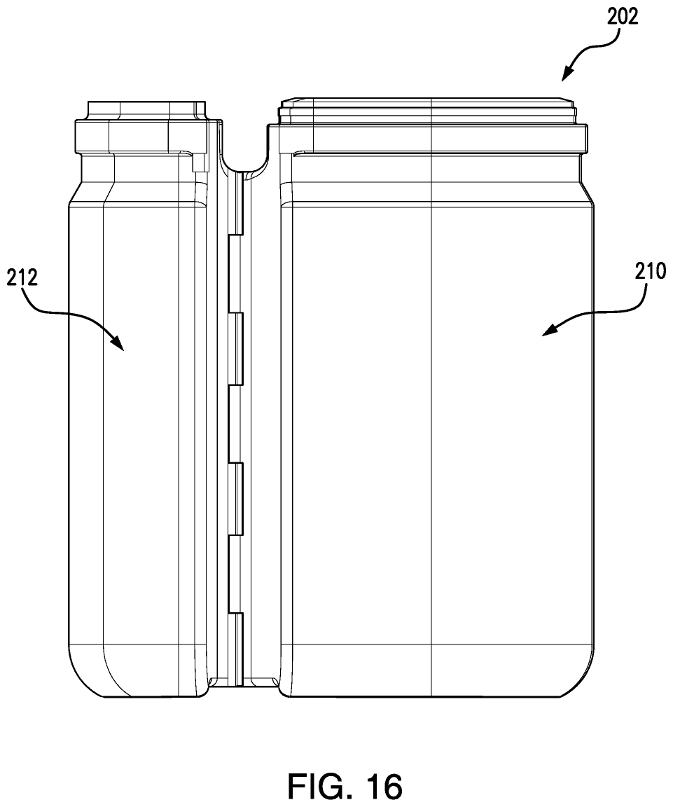

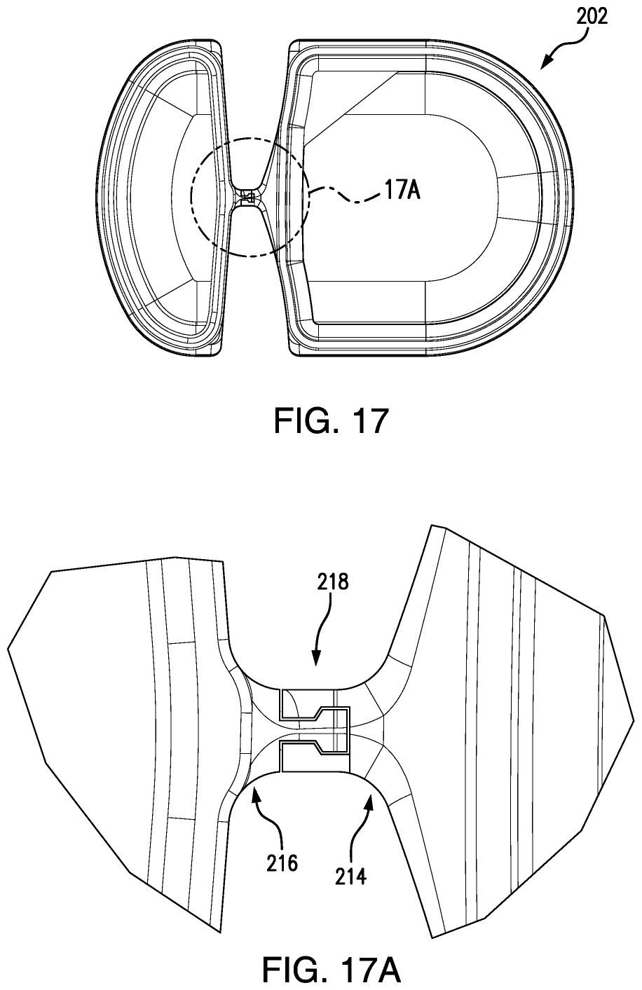

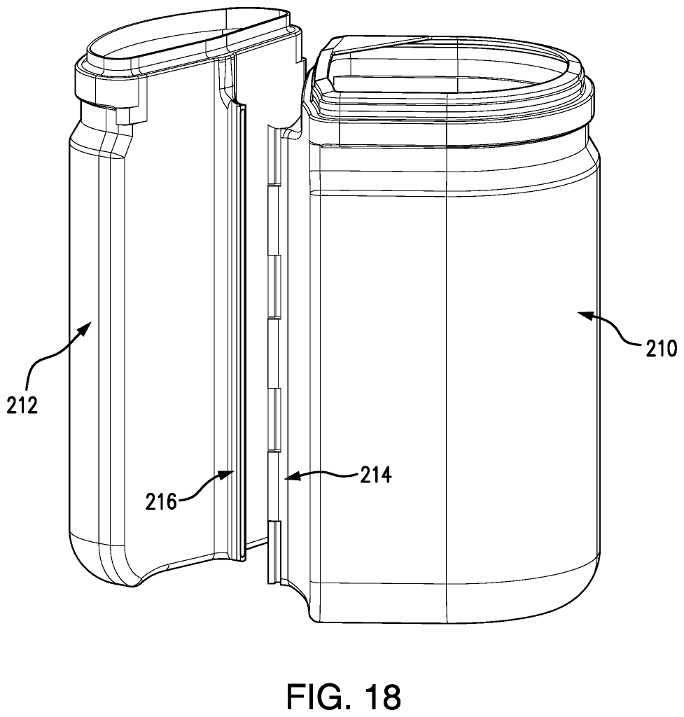

FIGS. 16-19A are views of an alternate two-part container body 202 usable with the same or similar scoop 32 and closure 24 as above. A first part 210 provides the first section of the assembled container body 202 and a second part 212 provides the second section. Mating web 214 and 216 sections (FIG. 17) of the two parts combine to form the web 218 between the two sections.

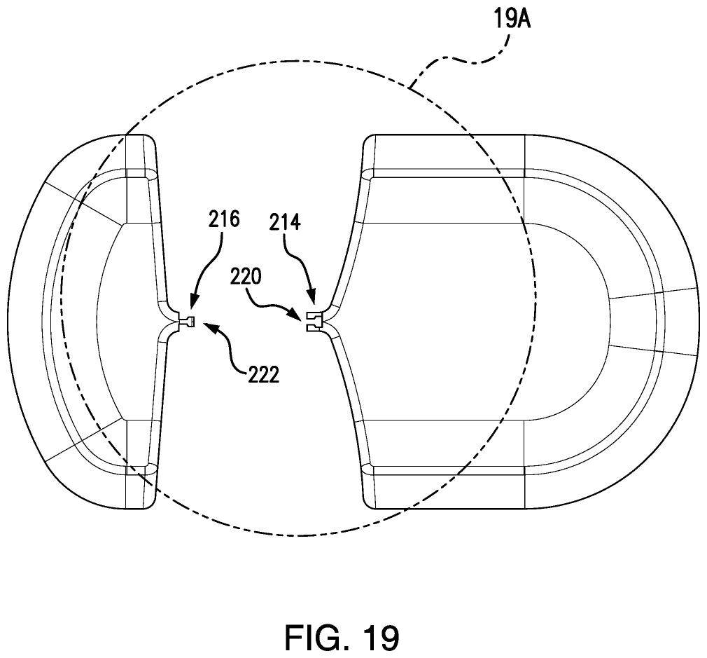

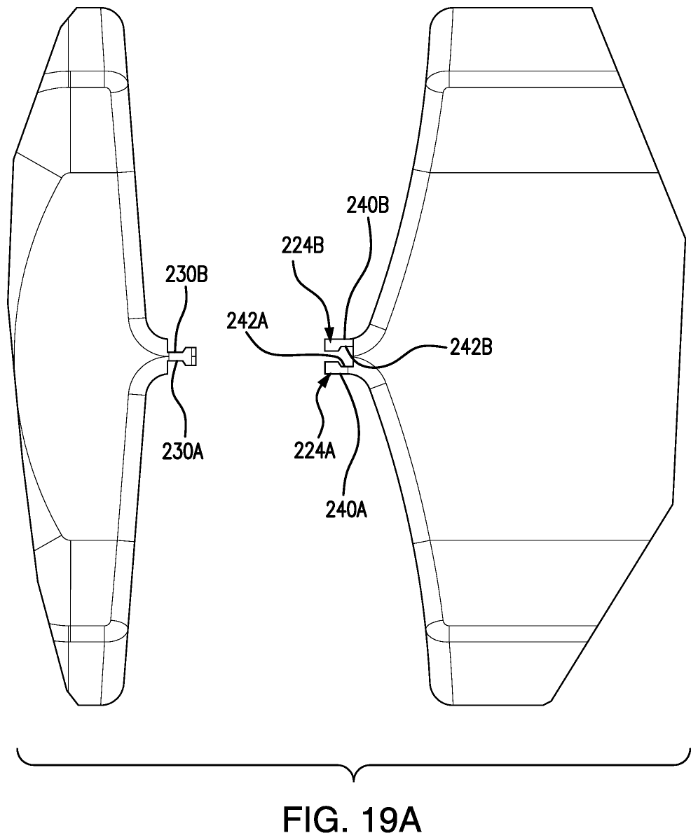

The two parts 210, 212 may each be separately molded (e.g., extrusion blow molded) of similar material to the single part body 22 above. The two parts may be separately molded and then mated/secured to each other. Mating/securing may comprise interfitting features and/or thermal, chemical, or adhesive bonding. Adhesive bonding may be direct or indirect. An indirect bonding may be via a label bonded to both parts. One particular example of interfitting features is a rail and channel. The drawings show a T-rail 222 (FIG. 19) on one part (the second) and a complementary channel 220 on the other. The exemplary channel has staggered interdigitated sidewall segments 224A and 224B (FIG. 19A) to allow ease of molding with spaced apart first segments 224A forming a first sidewall of the channel alternating with spaced apart second segments 224B forming the second sidewall and engaging the respective two sides 230A, 230B of the T-rail. In such a molding, the mold may have interdigitated bypass teeth on two mold pieces (mold steels) that draw together with a first mold piece forming outboard lateral faces 240A of the first segments and inboard faces 242B of the second segments and the second mold piece mold piece forming outboard lateral faces 240B of the second segments and inboard faces 242A of the first segments.

In such examples, the interfitting of the features provides lateral securement and the or thermal, chemical, or adhesive bonding locks relative vertical position. Additionally or alternatively, the interfitting features could provide vertical registry and locking. For example, the T-rail could have stops at its end capturing ends of the channel or could have one or more intermediate projections mutually capturing one or more adjacent channel wall segments.

Such a two part body allows one basic first part and scoop to be used with various sizes of second parts. Each combination would require a correspondingly sized/proportioned closure. The rationale behind this is that there is little variation in scoop size. For a given product, the exact same scoop would be used with several product volumes or weights (depending on how sold). Even moderate variations in scoop size for different products could still be accommodated in a given size of second part/second compartment.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, details of the particular product and associated use may influence details of particular implementations. Accordingly, other embodiments are within the scope of the following claims.

What is claimed is:

1. A container comprising:
a container body having a first compartment having a first opening and a second compartment having a second opening; and
a closure having:
a base mounted to the container body; and
a lid hinged to the base.

2. The container of claim 1 wherein:
the container body has a first rim at the first compartment and a second rim at the second compartment; and
the closure base has a wall engaging the container body around the first rim.

3. The container of claim 1 further comprising:
a scoop stored in the second compartment; and
a powder product stored in the first compartment.

4. The container of claim 3 further comprising:
a seal over the first compartment.

5. The container of claim 1 wherein the container body has:
a first section bounding the first compartment and extending to a first rim;
a second section bounding the second compartment and extending to the second rim; and
a web joining the first portion and second portion.

6. The system of claim 5 wherein:
the closure base has an interlocking engagement with a neck of the first section and a neck of the second section.

7. The container of claim 6 wherein:
the interlocking engagement with the neck of the first section and the neck of the second section is along portions of the neck of the first section and the neck of the second section facing outward but not along portions of the neck of the first section and neck of the second section facing each other.

8. The container of claim 1 wherein:
the first compartment has a generally D-shaped footprint with a first leg facing the second compartment and an opposite second leg, the first leg being relatively straight compared with the second leg.

9. The container of claim 1 wherein:
the container body comprises a laminate.

10. The container of claim 1 wherein:
the first compartment and the second compartment are of a single molding.

11. The container of claim 1 wherein:
the first compartment and the second compartment are of separate moldings.

12. The container of claim 11 wherein:
a first molding of the separate moldings has a T-sectioned rail; and
a second molding of the separate moldings has a channel receiving the rail.

13. The container of claim 12 wherein:
the channel has a first segmented sidewall and a second segmented sidewall; and
the segments of the first sidewall alternate with the segments of the second sidewall.

14. The container of claim 11 wherein:
the rail and the channel are bonded to each other.

15. A method for making the container of claim 1, the method comprising:
extrusion blow molding the container body, the extrusion blow molding including pinching to divide the second compartment from the first compartment; and
mating the closure to the container body.

16. The method of claim 15 further comprising:
placing a scoop in the second compartment; and
introducing a powder product to the first compartment.

17. The method of claim 16 further comprising:
after the introducing of the powder, applying a seal across the first compartment.

18. The method of claim 17 wherein:
the applying of the seal does not seal the second compartment.

19. The method of claim 15 wherein:
the mating of the closure is via downward translation relative to the container body.

20. A method for using the container of claim 1, the method comprising:
opening the closure from a closed condition to an open condition;
removing a scoop from the second compartment; and
using the scoop to scoop powdered product from the first compartment.
